(19) United States
(12) Patent Application Publication
(10) Pub. No.: US 2026/0082258 A1
(43) Pub. Date: Mar. 19, 2026

(54) PERFORMING MEASUREMENTS ASSOCIATED WITH CHANNEL MEASUREMENT RESOURCES USING RESTRICTED RECEIVE BEAM SUBSETS

(71) Applicant: QUALCOMM Incorporated, San Diego, CA (US)

(72) Inventors: Qiaoyu LI, Beijing (CN); Sony AKKARAKARAN, Poway, CA (US); Hamed PEZESHKI, San Diego, CA (US); Mahmoud TAHERZADEH BOROUJENI, San Diego, CA (US); Tao LUO, San Diego, CA (US)

(21) Appl. No.: 19/110,577

(22) PCT Filed: Oct. 12, 2022
(86) PCT No.: PCT/CN2022/124768

§ 371 Date: Mar. 11, 2025

(51) Int. Cl. H04W 24/10

(52) U.S. Cl. CPC H04W 24/10

(57) ABSTRACT

Various aspects of the present disclosure generally relate to wireless communication. In some aspects, a user equipment (UE) may receive, from a network node, a request to report measurements associated with channel measurement resources (CMRs). The UE may perform, during a time domain (TD) restriction window and based at least in part on the request, the measurements associated with the CMRs using receive (Rx) beams that are associated with a restricted Rx beam subset, wherein the restricted Rx beam subset is associated with the TD restriction window, and wherein the restricted Rx beam subset is a subset of a plurality of Rx beams associated with the UE. The UE may transmit, to the network node, a channel state information (CSI) report that indicates the measurements associated with the CMRs. Numerous other aspects are described.

### FIELD OF THE DISCLOSURE

Aspects of the present disclosure generally relate to wireless communication and to techniques and apparatuses for performing measurements associated with channel measurement resources (CMRs) using restricted receive (Rx) beam subsets.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory, and one or more processors, coupled to the memory, configured to: receive, from a network node, a request to report measurements associated with channel measurement resources (CMRs); perform, during a time domain (TD) restriction window and based at least in part on the request, the measurements associated with the CMRs using receive (Rx) beams that are associated with a restricted Rx beam subset, wherein the restricted Rx beam subset is associated with the TD restriction window, and wherein the restricted Rx beam subset is a subset of a plurality of Rx beams associated with the UE; and transmit, to the network node, a channel state information (CSI) report that indicates the measurements associated with the CMRs.

In some implementations, an apparatus for wireless communication at a network node includes a memory, and one or more processors, coupled to the memory, configured to: transmit, to a UE, a request to report measurements associated with CMRs; and receive, from the UE, a CSI report that indicates the measurements associated with the CMRs, wherein the measurements associated with the CMRs are associated with a TD restriction window and are performed based at least in part on Rx beams that are associated with a restricted Rx beam subset, and wherein the restricted Rx beam subset is associated with the TD restriction window.

In some implementations, a method of wireless communication performed by an apparatus of a UE includes receiving, from a network node, a request to report measurements associated with CMRs; performing, during a TD restriction window and based at least in part on the request, the measurements associated with the CMRs using Rx beams that are associated with a restricted Rx beam subset, wherein the restricted Rx beam subset is associated with the TD restriction window, and wherein the restricted Rx beam subset is a subset of a plurality of Rx beams associated with the UE; and transmitting, to the network node, a CSI report that indicates the measurements associated with the CMRs.

In some implementations, a method of wireless communication performed by an apparatus of a network node includes transmitting, to a UE, a request to report measurements associated with CMRs; and receiving, from the UE, a CSI report that indicates the measurements associated with the CMRs, wherein the measurements associated with the CMRs are associated with a TD restriction window and are performed based at least in part on Rx beams that are associated with a restricted Rx beam subset, and wherein the restricted Rx beam subset is associated with the TD restriction window.

In some implementations, a non-transitory computer-readable medium storing a set of instructions for wireless communication includes one or more instructions that, when executed by one or more processors of a UE, cause the UE to: receive, from a network node, a request to report measurements associated with CMRs; perform, during a TD restriction window and based at least in part on the request, the measurements associated with the CMRs using Rx beams that are associated with a restricted Rx beam subset, wherein the restricted Rx beam subset is associated with the TD restriction window, and wherein the restricted Rx beam subset is a subset of a plurality of Rx beams associated with the UE; and transmit, to the network node, a CSI report that indicates the measurements associated with the CMRs.

In some implementations, a non-transitory computer-readable medium storing a set of instructions for wireless communication includes one or more instructions that, when executed by one or more processors of a network node, cause the network node to: transmit, to a UE, a request to report measurements associated with CMRs; and receive, from the UE, a CSI report that indicates the measurements associated with the CMRs, wherein the measurements associated with the CMRs are associated with a TD restriction window and are performed based at least in part on Rx beams that are associated with a restricted Rx beam subset, and wherein the restricted Rx beam subset is associated with the TD restriction window.

In some implementations, an apparatus for wireless communication includes means for receiving, from a network node, a request to report measurements associated with CMRs; means for performing, during a TD restriction window and based at least in part on the request, the measurements associated with the CMRs using Rx beams that are associated with a restricted Rx beam subset, wherein the restricted Rx beam subset is associated with the TD restriction window, and wherein the restricted Rx beam subset is a subset of a plurality of Rx beams associated with the apparatus; and means for transmitting, to the network node, a CSI report that indicates the measurements associated with the CMRs.

In some implementations, an apparatus for wireless communication includes means for transmitting, to a UE, a request to report measurements associated with CMRs; and means for receiving, from the UE, a CSI report that indicates the measurements associated with the CMRs, wherein the measurements associated with the CMRs are associated with a TD restriction window and are performed based at least in part on Rx beams that are associated with a restricted Rx beam subset, and wherein the restricted Rx beam subset is associated with the TD restriction window.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of beam management, in accordance with the present disclosure.

FIG. 5 is a diagram illustrating an example of an artificial intelligence/machine learning (AI/ML)-based predictive beam management, in accordance with the present disclosure.

FIG. 6 is a diagram illustrating an example of a network-node-based beam pair prediction, in accordance with the present disclosure.

FIGS. 7-9 are diagrams illustrating examples associated with performing measurements associated with channel measurement resources (CMRs) using restricted receive (Rx) beam subsets, in accordance with the present disclosure.

FIGS. 10-11 are diagrams illustrating example processes associated with performing measurements associated with CMRs using restricted Rx beam subsets, in accordance with the present disclosure.

FIGS. 12-13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

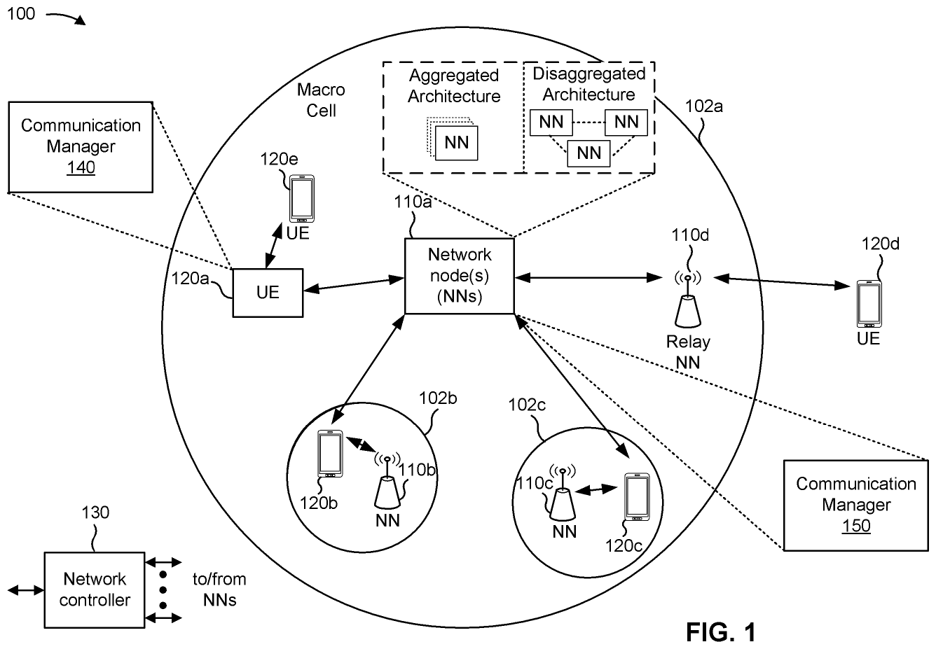

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network node, a request to report measurements associated with channel measurement resources (CMRs); perform, during a time domain (TD) restriction window and based at least in part on the request, the measurements associated with the CMRs using receive (Rx) beams that are associated with a restricted Rx beam subset, wherein the restricted Rx beam subset is associated with the TD restriction window, and wherein the restricted Rx beam subset is a subset of a plurality of Rx beams associated with the UE; and transmit, to the network node, a channel state information (CSI) report that indicates the measurements associated with the CMRs. Additionally, or alternatively, the communication manager 140 may perform one or more other operations described herein.

In some aspects, a network node (e.g., network node 110) may include a communication manager 150. As described in more detail elsewhere herein, the communication manager 150 may transmit, to a UE, a request to report measurements associated with CMRs; and receive, from the UE, a CSI report that indicates the measurements associated with the CMRs, wherein the measurements associated with the CMRs are associated with a TD restriction window and are performed based at least in part on Rx beams that are associated with a restricted Rx beam subset, and wherein the restricted Rx beam subset is associated with the TD restriction window. Additionally, or alternatively, the communication manager 150 may perform one or more other operations described herein.

As indicated above, FIG. 1 is provided as an example. Other examples may differ from what is described with regard to FIG. 1.

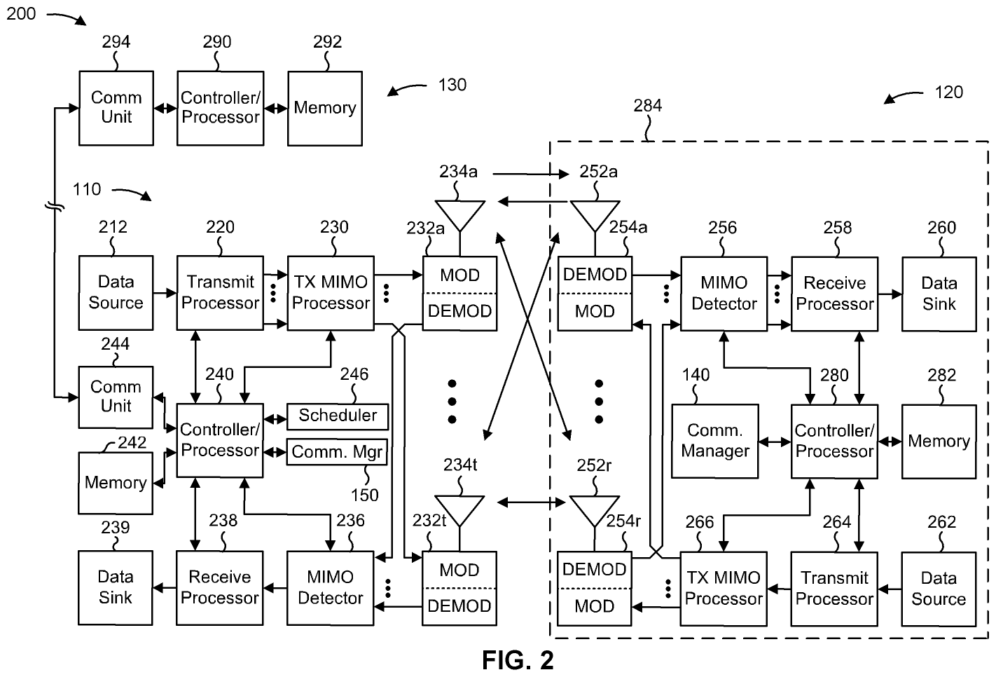

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

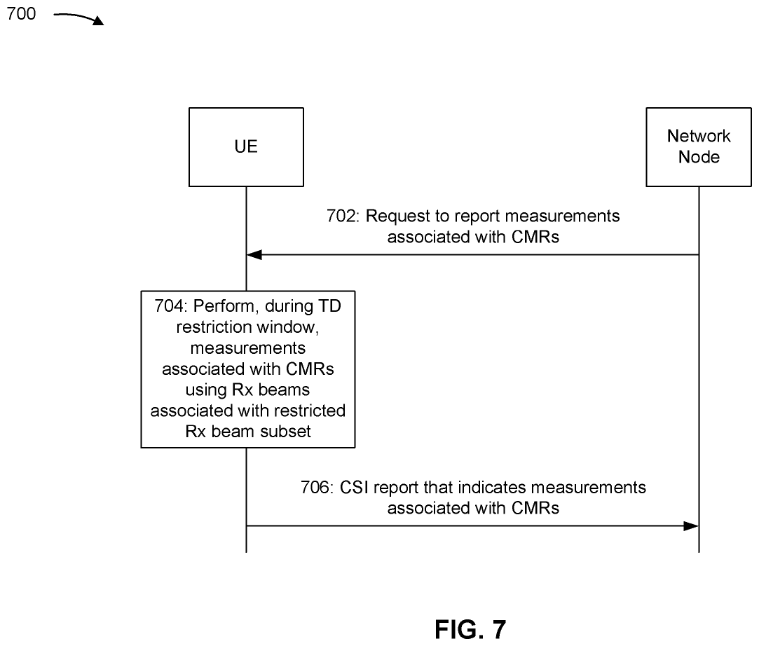

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-13).

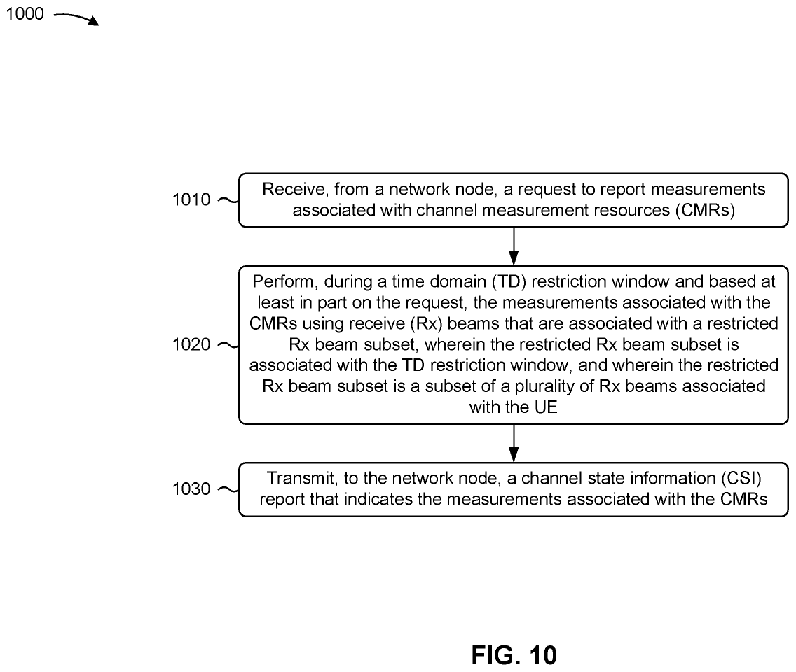

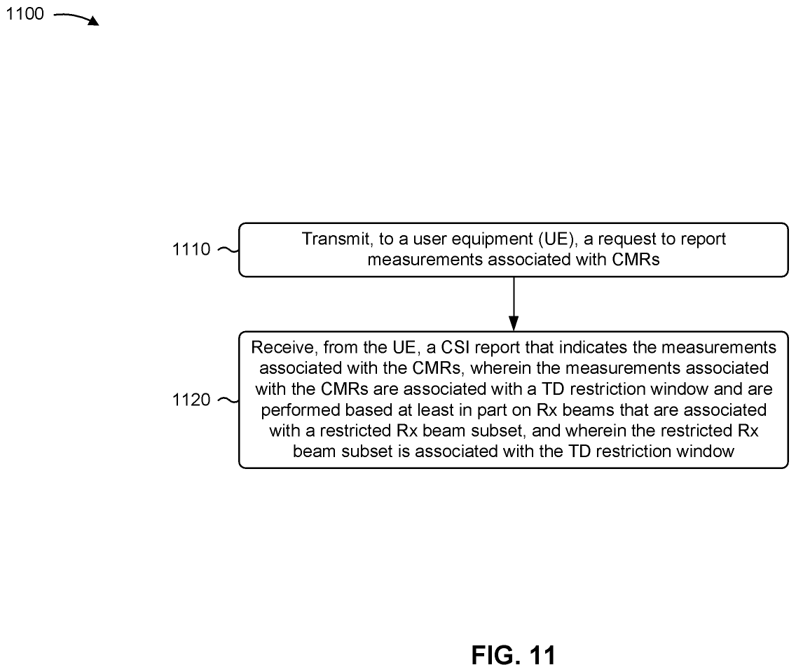

The controller/processor 240 of the network node 110, the controller/processor 280 of the UE 120, and/or any other component(s) of FIG. 2 may perform one or more techniques associated with performing measurements associated with CMRs using restricted Rx beam subsets, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network node, a request to report measurements associated with CMRs; means for performing, during a TD restriction window and based at least in part on the request, the measurements associated with the CMRs using Rx beams that are associated with a restricted Rx beam subset, wherein the restricted Rx beam subset is associated with the TD restriction window, and wherein the restricted Rx beam subset is a subset of a plurality of Rx beams associated with the UE; and/or means for transmitting, to the network node, a CSI report that indicates the measurements associated with the CMRs. In some aspects, the means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting, to a UE, a request to report measurements associated with CMRs; and/or means for receiving, from the UE, a CSI report that indicates the measurements associated with the CMRs, wherein the measurements associated with the CMRs are associated with a TD restriction window and are performed based at least in part on Rx beams that are associated with a restricted Rx beam subset, and wherein the restricted Rx beam subset is associated with the TD restriction window. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

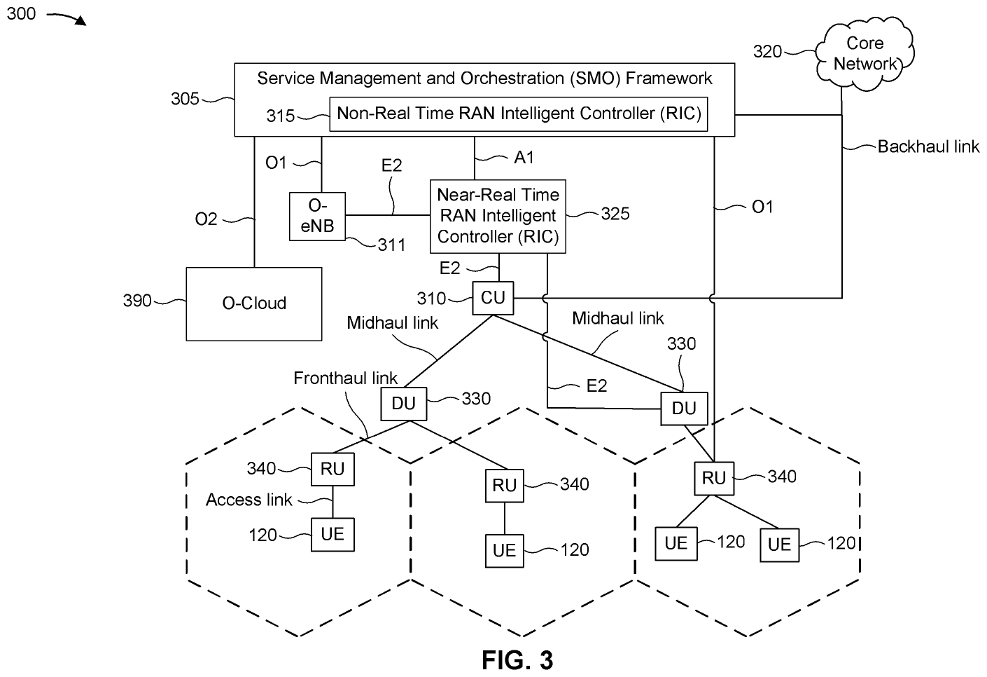

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

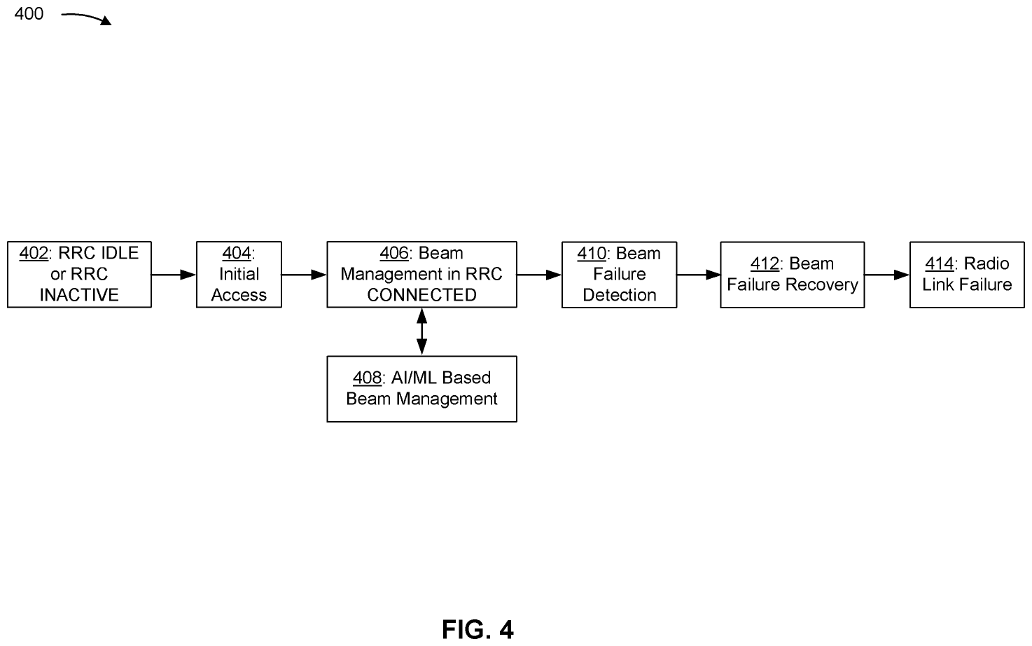

FIG. 4 is a diagram illustrating an example 400 of beam management, in accordance with the present disclosure.

As shown by reference number 402, a UE may initially be in an RRC idle state or an RRC inactive state. As shown by reference number 404, the UE may perform an initial access. As shown by reference number 406, the UE may perform beam management after entering an RRC connected state. The beam management may include P1, P2, and/or P3 beam management procedures. The P1 beam management procedure may be a beam selection procedure, an initial beam acquisition procedure, a beam sweeping procedure, a cell search procedure, and/or a beam search procedure. The P2 beam management procedure may be a beam refinement procedure, a network node beam refinement procedure, a TRP beam refinement procedure, and/or a transmit (Tx) beam refinement procedure. The P3 beam management procedure may be a beam refinement procedure, a UE beam refinement procedure, and/or an Rx beam refinement procedure. As shown by reference number 408, the UE may also perform beam management using an AI/ML-based approach. The beam management using the AI/ML-based approach may use an AI/ML model in a spatial domain (SD), a TD, and/or a frequency domain (FD), which may reduce signaling overhead and latency and improve a beam selection accuracy. The AI/ML model may be associated with lifecycle management, which may involve model training, model deployment, model inference, model monitoring, and/or model updating. As shown by reference number 410, the UE may perform a beam failure detection (BFD), which may be based at least in part on measurements obtained during the beam management after entering the RRC connected mode. As shown by reference number 412, the UE may perform a beam failure recovery (BFR) based at least in part on the BFD. As shown by reference number 414, when the BFR is not successful, the UE may declare a radio link failure (RLF).

As indicated above, FIG. 4 is provided as an example. Other examples may differ from what is described with regard to FIG. 4.

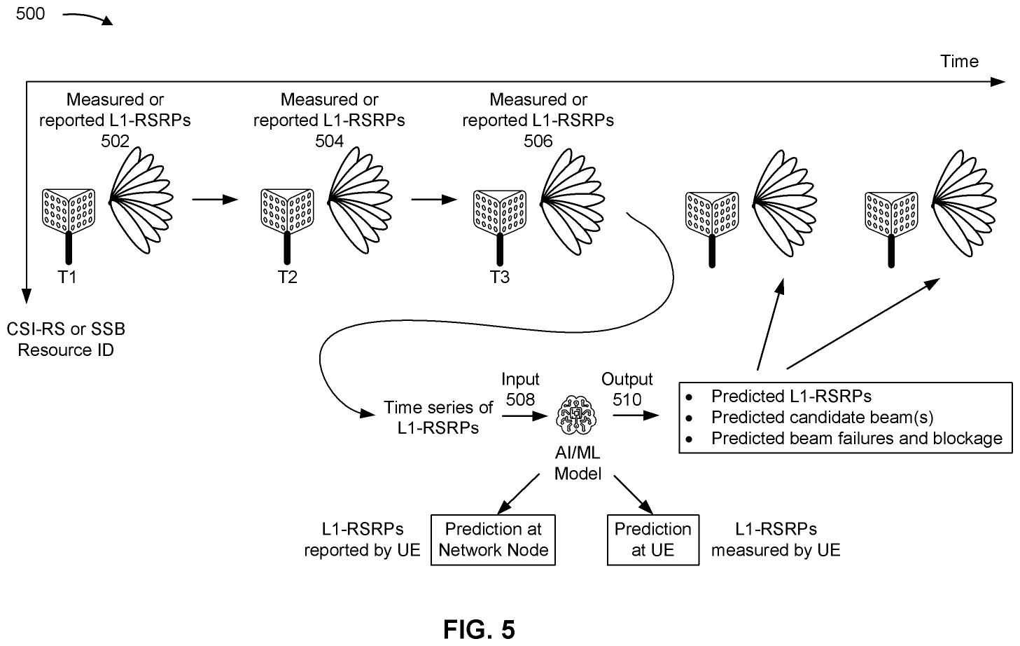

FIG. 5 is a diagram illustrating an example 500 of an AI/ML-based predictive beam management, in accordance with the present disclosure.

As shown by reference number 502, in an AI/ML-based predictive beam management, a network node may, at a first time, transmit a plurality of first channel state information reference signals (CSI-RSs) or synchronization signal blocks (SSBs). The first CSI-RSs/SSBs may be associated with first CMRs. A UE may perform first layer 1 RSRP (L1-RSRP) and/or signal-to-interference-plus-noise ratio (SINR) measurements based at least in part on the plurality of first CSI-RSs/SSBs. The UE may report the first L1-RSRP/SINR measurements to the network node. As shown by reference number 504, the network node may, at a second time, transmit a plurality of second CSI-RSs/SSBs. The second CSI-RSs/SSBs may be associated with second CMRs. The UE may perform second L1-RSRP/SINR measurements based at least in part on the plurality of second CSI-RSs/SSBs. The UE may report the second L1-RSRP/SINR measurements to the network node. As shown by reference number 506, the network node may, at a third time, transmit a plurality of third CSI-RSs/SSBs. The third CSI-RSs/SSBs may be associated with third CMRs. The UE may perform third L1-RSRP/SINR measurements based at least in part on the plurality of third CSI-RSs/SSBs. The UE may report the third L1-RSRP/SINR measurements to the network node.

As shown by reference number 508, a time series of L1-RSRP/SINR measurements (e.g., the first, second, and third L1-RSRP/SINR measurements) may be provided as an input to an AI/ML model capable of performing the AI/ML-based beam prediction. The AI/ML model may run on either the network node or the UE. When the AI/ML-based beam prediction is performed at the network node, the input may be L1-RSRP/SINR measurements reported by the UE. When the AI/ML-based beam prediction is performed at the UE, the input may be L1-RSRP/SINR measurements measured by the UE. As shown by reference number 510, the AI/ML model may produce an output based at least in part on the input, where the output may indicate predicted L1-RSRP/SINR measurements, predicted candidate beam(s), and/or predicted beam failure/blockage. In other words, the output may be based at least in part on the time series of L1-RSRP/SINR measurements. The AI/ML-based beam prediction may result in a reduced UE power or UE-specific reference signal overhead, as well as better latency and throughput.

As indicated above, FIG. 5 is provided as an example. Other examples may differ from what is described with regard to FIG. 5.

AI/ML-based predictive beam management may involve beam management using AI/ML. In traditional beam management procedures, beam qualities/failures may be identified via measurements, which may involve more power/overhead for achieving good performance. A beam accuracy may be limited due to restrictions on power/overhead, and latency/throughput may be impacted by beam resuming efforts. AI/ML-based predictive beam management may provide predictive beam management in an SD, a TD, and/or an FD, which may result in power/overhead reduction and/or accuracy/latency/throughput improvement. AI/ML-based predictive beam management may predict non-measured beam qualities, which may result in lower power/overhead or better accuracy. For example, AI/ML-based predictive beam management may predict future beam blockage/failure, which may result in better latency/throughput. AI/ML-based predictive beam management may be useful because beam prediction is a highly non-linear problem. Predicting future Tx beam qualities may depend on a UE's moving speed/trajectory, Rx beams used or to be used, and/or interference, which may be difficult to model via conventional statistical signal processing techniques.

AI/ML-based predictive beam management may involve the prediction of beams via AI/ML at the UE or at a network node, which may involve a tradeoff between performance and UE power. In order to predict future DL-Tx beam qualities, the UE may have more observations (via measurements) than the network node (via UE feedbacks). Thus, beam prediction at the UE may outperform beam prediction at the network node, but may involve more UE power consumption. Model training may occur at the network node or at the UE. For model training at the network node, data may be collected via an air interface or via application-layer approaches. For model training at the UE, additional UE computation/buffering capabilities may be used for model training and data storage.

In an L1-RSRP/L1-SINR reporting framework, a UE may be configured with one or more parameters for joint SSB resource indicator (SSBRI) and/or CSI-RS resource indicator (CRI) and L1-RSRP and/or L1-SINR beam reporting. The UE may report a set of CSI measurements associated with one or more beams. For example, the UE may be configured with parameters ReportQuantity=ssb-Index-RSRP, ssb-Index-SINR, cri-RSRP, and/or cri-SINR for joint SSBRI/CRI and L1-RSRP/L1-SINR beam reporting. In some cases, the UE may report CSI measurements (e.g., using a parameter nrofReportedRS). The reporting of CSI measurements may be configured (e.g., using RRC) depending on the capability of the UE. For example, the parameter nrofReportedRS may be two or four, depending on the capability of the UE. The UE may report the parameter nrofReportedRS for different SSBRIs or CRIs for each CSI report configuration.

For an L1-RSRP reporting, for a strongest SSBRI (e.g., an SSBRI corresponding to a signal strength and/or quality that is greater than the signal strength and/or quality of any other SSBRI that is measured by the UE during a specified time period), seven bits may be used to report a corresponding RSRP (in the range of [−140, −44] dBm with a 1 dBm step size). For remaining SSBRI(s) and/or CRI(s), four bits may be used to report a differential RSRP in the range of [0, −30] dB with a 2 dB step size and a reference to the L1-RSRP of the strongest SSBRI and/or CRI. For the strongest SSBRI/CRI's L1-RSRP, there may be invalid codepoints considering 2⁷=128 but 140−44+1=97. A mapping between the reported 7-bits/4-bits code-points and the actually measured RSRP values may be defined.

For an L1-SINR reporting, for a strongest SSBRI and/or CRI, seven bits may be used to report SINR in the range of [−23, 40] dB with a 0.5 dB step size. For remaining SSBRI(s)/CRI(s), four bits may be used to report a differential SINR in the range of [0, −15] dB with a 1 dB step size and a reference to the strongest SSBRI/CRI's L1-SINR. For the strongest and the remaining SSBRI(s)/CRI(s), there may be no invalid codepoints, but an SINR_0 may stand for SINR<−23 dB for the strongest SSBRI/CRI, while a DIFFSINR_15 may stand for ΔSINR≤−15 dB. A mapping between the reported 7-bits/4-bits code-points and the actually measured SINR values may be defined.

For an AI/ML-based predictive beam management, a first case of beam management and a second case of beam management may be supported for characterization and baseline performance evaluations. In the first case, an SD downlink beam prediction for a Set A of beams may be based at least in part on measurement results of a Set B of beams. In the second case, a temporal downlink beam prediction for a Set A of beams may be based at least in part on historic measurement results of a Set B of beams.

For the first case and the second case, a first alternative and a second alternative may be defined. In the first alternative, beams in Set A and beams in Set B may be in the same frequency range. With respect to the first case, the beams in Set B may be a subset of the beams in Set A. A quantity of beams in Set A and a quantity of beams in Set B may be defined. The beams in Set B may be determined from the beams in Set A based at least in part on a fixed pattern or a random pattern. In the second alternative, the beams in Set A may be different than the beams in Set B (e.g., the beams in set B may not be a subset of the beams in Set A). For example, the beams in Set A may be associated with narrow beams, and the beams in Set B may be associated with wide beams. A quantity of beams in Set A and a quantity of beams in Set B may be defined. A quasi-co-location (QCL) relation may be defined between beams in Set A and beams in Set B. With respect to the first alternative and the second alternative, Set A may be associated with a downlink beam prediction and Set B may be associated with a downlink beam measurement. A codebook construction for Set A and a codebook construction for Set B may be defined.

In the first case, beams in set A may be different than beams in Set B (e.g., the beams in set B may not be a subset of the beams in Set A), or alternatively, beams in Set B may be a subset of beams in Set A. In the second case, beams in set A may be different than beams in Set B (e.g., the beams in set B may not be a subset of the beams in Set A), beams in Set B may be a subset of beams in Set A, or beams in Set A may be the same as beams in Set B. For the first case and the second case, Set A and Set B being associated with different beams and Set B being associated with a subset of Set A may be supported for AI/ML model training. The AI/ML model training may occur at a network side and/or at a UE side. For the first case and the second case, predicted beams may be associated with a downlink Tx beam prediction, downlink Rx beam prediction, and/or a beam pair prediction, where a beam pair may include a downlink Tx beam and a corresponding downlink Rx beam. An AI/ML model inference may be facilitated based at least in part on enhanced or new configurations, UE reporting, and/or UE measurements (e.g., enhanced or new beam measurement and/or beam reporting). The AI/ML model inference may be facilitated based at least in part on an enhanced or new signaling for measurement configuration/triggering, and/or a signaling of assistance information.

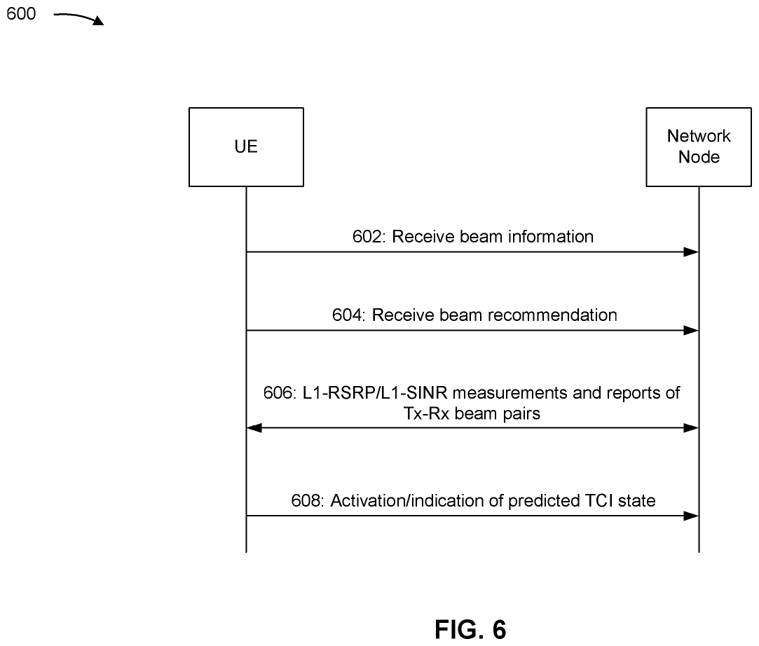

FIG. 6 is a diagram illustrating an example 600 of a network-node-based beam pair prediction, in accordance with the present disclosure. As shown in FIG. 6, example 600 includes communication between a UE (e.g., UE 120) and a network node (e.g., network node 110). In some aspects, the UE and the network node may be included in a wireless network, such as wireless network 100.

As shown by reference number 602, the UE may transmit, to the network node, Rx beam information, which may consider UE rotation/orientation and hierarchical levels of Rx beam widths. As shown by reference number 604, the UE may transmit, to the network node, an Rx beam recommendation, which may indicate a recommendation of which Rx beams should be measured and reported, and which Rx beams should be predicted by the network node. As shown by reference number 606, the UE may transmit, to the network node, an indication of L1-RSRP/L1-SINR measurements and reports of Tx-Rx beam pairs. The network node may transmit, to the UE, an indication of a beam pair prediction based at least in part on the L1-RSRP/L1-SINR measurements and reports of Tx-Rx beam pairs. The beam pair prediction may be a network-node-based beam pair prediction. As shown by reference number 608, the network node may transmit, to the UE, an activation/indication of a predicted transmission configuration indicator (TCI) state regarding an Rx beam or a Tx-Rx beam pair for receiving a scheduled physical downlink shared channel (PDSCH). Further, the network node may indicate, to the UE, a confidence level associated with the Rx beam or the Tx-Rx beam pair for receiving the scheduled PDSCH.

As indicated above, FIG. 6 is provided as an example. Other examples may differ from what is described with regard to FIG. 6.

Beam pair qualities (e.g., Tx and Rx beams) may be predicted. For example, a network node may rely on spatially down-sampled L1-RSRP measurements of beam-pairs to predict L1-RSRP measurements of other beam pairs. A network-node-based beam pair prediction may reduce a UE power consumption associated with running an AI/ML model. A UE may report, to the network node, Rx beam pointing direction information, beam width information, and/or UE orientation information, which may facilitate the network-node-based beam pair prediction. However, one problem with this approach is that UE-side proprietary information may be disclosed. An implementation of UE Rx beams may conventionally be proprietary information. Another problem with this approach is that Rx beams may need to be determined and reported by the UE. A relatively large overhead for reporting L1-RSRP measurements of beam pairs may be needed for the network-node-based beam pair prediction. Further, in some cases, the network node may have a better understanding, as compared to the UE, on which Rx beams should be used to obtain the L1-RSRP measurements depending on a current beam prediction (e.g., depending on a confidence level of the current beam prediction, as some missing Rx beams may lead to a lower beam prediction confidence level, and measurements at those missing Rx beams may be needed).

In various aspects of techniques and apparatuses described herein, a UE may receive, from a network node, a request to report measurements associated with CMRs. The UE may perform, during a TD restriction window and based at least in part on the request, the measurements associated with the CMRs using Rx beams that are associated with a restricted Rx beam subset. The restricted Rx beam subset may be associated with the TD restriction window. The restricted Rx beam subset may be a subset of a plurality of Rx beams associated with the UE. Different TD restriction windows may be associated with different restricted Rx beam subsets. The UE may transmit, to the network node, a CSI report that indicates the measurements associated with the CMRs.

In some aspects, in order to minimize disclosing UE-side proprietary information and to further reduce a UE reporting overhead for a network-node-based beam pair prediction, the UE may be configured with the TD restriction window, such that the Rx beams that the UE uses to measure Tx beams may be the same (or within a certain Rx beam subset) within the TD restriction window. The Rx beams that the UE uses may be from the restricted Rx beam subset. For example, a first TD restriction window may be associated with first Rx beam restrictions, a second TD restriction window may be associated with second Rx beam restrictions, and so on. Within a certain TD restriction window, Rx beam restrictions may refer to Rx beams that the UE uses within that TD restriction window, where the Rx beams may be associated with the restricted Rx beam subset. Specific Rx beams (or restricted Rx beam subsets) to be used in different TD restriction windows may be standard predefined and/or configured by the network node via RRC signaling. When the UE is configured with the TD restriction windows, the UE may not explicitly report its Rx beam information and/or orientation regarding an overall quantity of Rx beams. Rather, the UE may only report a certain quantity of Rx beam identifiers (IDs) (together with first order beam width information). Such Rx beam restrictions may reduce an L1 report overhead as compared to reporting beam pair IDs. Alternatively, the network node may dynamically control specific Rx beams (or Rx beam subsets) to be used in the TD restriction window for respective Tx beams. For example, the network node may use a medium access control control element (MAC-CE) or downlink control information (DCI) to dynamically control specific Rx beams (or Rx beam subsets) to be used in the TD restriction window for respective Tx beams.

In some aspects, by implementing the TD restriction window, less UE proprietary information may be disclosed while still facilitating a network-node-based beam pair prediction, and a lower UE reporting overhead may be achieved. As an example, an AI/ML model dedicated for certain UEs may be offline trained by a UE/modem vendor. The network node may download the AI/ML model from a third-party server, which may be operated by the UE/modem vendor. The AI/ML model may be dedicated for certain UEs and may not suitably perform for other types of UEs.

FIG. 7 is a diagram illustrating an example 700 associated with performing measurements associated with CMRs using restricted Rx beam subsets, in accordance with the present disclosure. As shown in FIG. 7, example 700 includes communication between a UE (e.g., UE 120) and a network node (e.g., network node 110). In some aspects, the UE and the network node may be included in a wireless network, such as wireless network 100.

As shown by reference number 702, the UE may receive, from a network node, a request to report measurements associated with CMRs. The network node may request the UE to report the measurements associated with CMRs via a CSI report from the UE. The network node may use the measurements associated with the CMRs for an AI/ML-based beam prediction (or beam pair prediction) at the network node.

As shown by reference number 704, the UE may perform, during a TD restriction window and based at least in part on the request, the measurements associated with the CMRs using Rx beams that are associated with a restricted Rx beam subset. The restricted Rx beam subset may be associated with the TD restriction window. The restricted Rx beam subset may be a subset of a plurality of Rx beams associated with the UE. Different TD restriction windows may be associated with different restricted Rx beam subsets.

In some aspects, the UE may use TD window restricted Rx beams for L1-RSRP measurement reports. In other words, the Rx beams may be associated with the TD restriction window, and the L1-RSRP measurement reports may be for the Rx beams that are associated with the TD restriction window. The UE may receive, from the network node, a request to report L1-RSRP/L1-SINR measurements associated with a set of CMRs. The set of CMRs may be associated with SSBs and/or CSI-RSs. The network node may request the UE to report the L1-RSRP/L1-SINR measurements associated with the set of CMRs. During a certain TD restriction window, Rx beams that may be used by the UE to measure the CMRs may be restricted to a certain subset of Rx beams (e.g., a restricted Rx beam subset) that are associated with the UE. In other words, the UE may be configured with a set of Rx beams, but during the certain TD restriction window, the UE may only use the subset of Rx beams to measure the CMRs. The UE may use different subsets of Rx beams during different TD restriction windows.

In some aspects, during the same TD restriction window, the UE may report, together with L1-RSRP/L1-SINR measurements and corresponding CMR IDs, specific IDs of the Rx beams within the restricted Rx beam subset that are actually used to determine the reported L1-RSRP/L1-SINR measurements for the respective CMRs. In other words, the UE may report, via a CSI report, the L1-RSRP/L1-SINR measurements and the corresponding CMR IDs, as well as indicate which specific Rx beams (e.g., via the Rx beam IDs) are used to derive the reported L1-RSRP/L1-SINR measurements for the respective CMR IDs. As a result, the network node may be notified regarding which Rx beams were used to determine the reported L1-RSRP/L1-SINR measurements for the respective CMR IDs.

In some aspects, the UE may transmit, to the network node and prior to the request, an indication of a quantity associated with the plurality of Rx beams associated with the UE. In some aspects, the UE may transmit, to the network node and prior to the request, beam information that indicates a beam level associated with each of the plurality of Rx beams associated with the UE, and/or an antenna panel associated with each of the plurality of Rx beams associated with the UE.

In some aspects, the UE may report, to the network node, a total Rx beam number and first order beam information. The UE may report the total Rx beam number before the UE is requested by the network node to report the CSI report. As an example, the UE may report that the UE has in total 63 Rx beams, and that only 7 of the 63 Rx beams should be restricted for use during a TD restriction window. The UE may report the first order beam information before the UE is requested by the network node to report the CSI report. As an example, the UE may report that Rx-beam #1 to Rx-beam #15 are widest beams (e.g., level-1 beams), Rx-beam #16 to Rx-beam #29 are narrow beams (e.g., level-2 beams), and Rx-beam #30 to Rx-beam #63 are most narrow beams (e.g., level-3 beams). As another example, the UE may report that Rx beams #1 to #21, #22 to #44, and #45 to #46} are associated with a first, second, and third antenna panel, respectively.

In some aspects, the UE may receive, from the network node, an indication that a periodic CSI report or a semi-persistent CSI report is configured or activated. In some aspects, N subsequent consecutive periodic or semi-persistent reports may be based at least in part on the restricted Rx beam subset in accordance with the TD restriction window. In some aspects, the Rx beams that are used for performing the measurements associated with the CMRs may be based at least in part on the restricted Rx beam subset for N consecutive slots or subframes in accordance with the TD restriction window. Further, N may be configured via a periodic CSI report setting or a semi-persistent CSI report setting, or N may be indicated based at least in part on the semi-persistent CSI report being activated.

In some aspects, standard predefined and/or network-node-controlled restrictions for TD restriction windows may be associated with UE Rx beams. In some aspects, a standard predefinition may predefine that after a periodic or semi-persistent CSI report is configured or activated, each N consecutive numbers of periodic or semi-persistent CSI reports should be based at least in part on the same subset of Rx beams. The Rx beams may be based at least in part on the same subset of Rx beams for a consecutive number of N slots or subframes or milliseconds (ms). In some aspects, the network node may configure or indicate the value of N. For example, the value of N may be RRC configured by a periodic or semi-persistent CSI report setting, and the value of N may be indicated via a MAC-CE when activating a semi-persistent CSI report. The network node may configure or indicate information regarding the restriction of Rx beams.

In some aspects, the UE may receive, from the network node, an indication of M restricted Rx beam subsets and corresponding Rx beam identifiers, where the restricted Rx beam subset may be one of the M restricted Rx beam subsets. The M restricted Rx beam subsets may be used in a round-robin manner among different TD restriction windows. For example, a first restricted Rx beam subset may be used, a second restricted Rx beam subset may be used, a third restricted Rx beam subset may be used, and then the first restricted Rx beam subset may be used again in accordance with the round-robin manner. In some aspects, the UE may determine, from the M restricted Rx beam subsets configured by the network node, the Rx beams to be used for performing the measurements associated with the CMRs. In some aspects, the UE may receive, from the network node, an indication of the Rx beams to be used for performing the measurements associated with the CMRs during the TD restriction window.

In some aspects, the network node may control UE Rx beam restrictions. The network node may preconfigure M subsets of Rx beams in the periodic or semi-persistent CSI report setting, where each subset of Rx beams may include Rx beam IDs within a UE reported total number of Rx beams. The M subsets of Rx beams may be associated with restricted Rx beam subsets. In some aspects, the network node may preconfigure the M subsets in a round-robin manner, such that the M subsets may be round-robin used among different TD restriction windows. In some aspects, the UE may still determine particular Rx beams to be used, but may optionally report specifically used Rx beam IDs when reporting L1-RSRP/L1-SINR measurements together with respective CMR IDs. In some aspects, the network node may configure a specific Rx beam that the UE should use for a particular CMR during an associated TD restriction window, in which case the UE may not report an Rx beam ID when reporting the L1-RSRP/L1-SINR measurement.

In some aspects, the UE may receive, from the network node, an indication that dynamically changes the Rx beams to be used for performing the measurements associated with the CMRs or the restricted Rx beam subset associated with the TD restriction window. In some aspects, the UE may receive, from the network node, an indication that dynamically changes the TD restriction window.

In some aspects, the network node may dynamically change the UE Rx beam restrictions. As an example, a semi-persistent CSI report setting may indicate multiple Rx beam subset options, and a MAC-CE activating a semi-persistent CSI report may indicate one of the options. As another example, a MAC-CE activating a semi-persistent CSI report may explicitly indicate Rx beams that the UE should use before the semi-persistent CSI report is deactivated. As another example, an aperiodic CSI report triggering state configuration may configure Rx beams that the UE should use for an aperiodic CSI report, and the UE may identify particular Rx beams and reporting options when the UE is triggered with the aperiodic CSI report via DCI. As another example, the UE may receive a DCI that includes dedicated fields to alter the UE's Rx beam restrictions to an alternative option regarding a certain CSI report. In some aspects, the semi-persistent CSI report setting, the MAC-CE activating the semi-persistent CSI report, and/or the aperiodic CSI report triggering state configuration may indicate whether restricted Rx beam subsets are used in a round-robin manner among different TD restriction windows, whether the UE determines particular Rx beams to be used, and/or whether the network node configures specific Rx beams that the UE should use for particular CMRs during an associated TD restriction window.

In some aspects, the network node may dynamically change the TD restriction windows. As an example, a MAC-CE activating a semi-persistent CSI report may indicate the value of N, which may be indicated explicitly or may be based at least in part on an option ID out of multiple options configured in an associated CSI report setting. As another example, the UE may receive a DCI that includes dedicated fields to alter the value of N to an alternative value regarding a certain CSI report.

In some aspects, the UE may transmit, to the network node, an indication of a recommendation for one or more of the Rx beams, the restricted Rx beam subset, or the TD restriction window. The UE may receive, from the network node, a configuration of one or more of the Rx beams, the restricted Rx beam subset, or the TD restriction window based at least in part on the indication of the recommendation.

In some aspects, the UE may report Rx beam restriction patterns. Network node configured or indicated options may instead be reported by the UE as recommendations. For example, the UE may recommend, to the network node, a time domain window restriction on UE Rx beams, the N consecutive numbers of periodic or semi-persistent CSI reports, the M subsets of Rx beams, and/or dynamically changed UE Rx beam restrictions or TD restriction windows. The network node configurations or indications may serve as confirmations or alternations of UE recommendations. In other words, the network node may configure the UE based at least in part on the UE recommendation, or the network node may configure the UE without considering the UE recommendation. Alternatively, the network node configurations or indications may be refrained, and Rx beam restrictions may only depend on UE reporting. Such UE reporting may be carried by UE capability reporting, which may be via RRC signaling or via an uplink MAC-CE.

As shown by reference number 706, the UE may transmit, to the network node, a CSI report that indicates the measurements associated with the CMRs, where the measurements associated with the CMRs may be based at least in part on the Rx beams that are associated with the restricted Rx beam subset and the TD restriction window. In some aspects, the CSI report may indicate identifiers of the Rx beams associated with the restricted Rx beam subset that are used for performing the measurements associated with the CMRs. As a result, the network node may be able to determine for which specific Rx beams the CSI report is applicable.

As indicated above, FIG. 7 is provided as an example. Other examples may differ from what is described with regard to FIG. 7.

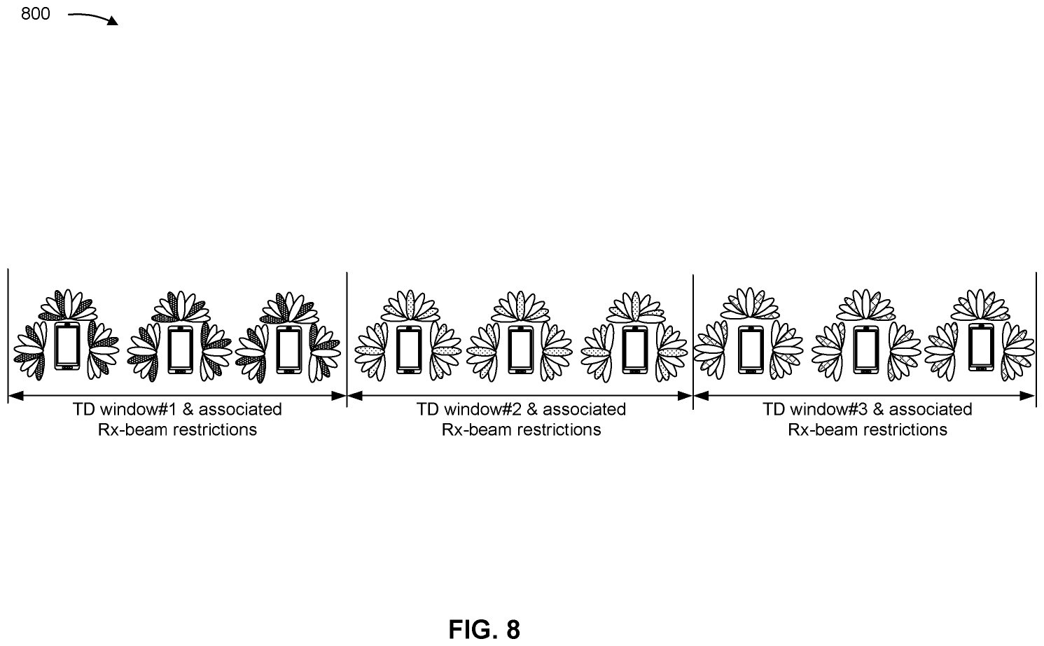

FIG. 8 is a diagram illustrating an example 800 associated with performing measurements associated with CMRs using restricted Rx beam subsets, in accordance with the present disclosure.

As shown in FIG. 8, a UE may be configured with a TD restriction window, during which Rx beams that the UE uses to measure Tx beams may be the same. In other words, the UE may use the same Rx beams during the TD restriction window to measure the Tx beams. For example, a first TD restriction window may be associated with first Rx beam restrictions, a second TD restriction window may be associated with second Rx beam restrictions, and a third TD restriction window may be associated with third Rx beam restrictions. The first Rx beam restrictions may correspond to Rx beams that the UE may use during the first TD restriction window, the second Rx beam restrictions may correspond to Rx beams that the UE may use during the second TD restriction window, and the third Rx beam restrictions may correspond to Rx beams that the UE may use during the third TD restriction window.

In some aspects, the UE may transmit, to a network node, an L1 report (e.g., for the second TD restriction window). The L1 report may indicate an L1-RSRP measurement for a corresponding CMR ID and an Rx beam ID. For example, the L1 report may indicate an L1-RSRP measurement of −86 dBm for CMR ID #3 and Rx beam ID #0, an L1-RSRP measurement of −88 dBm for CMR ID #4 and Rx beam ID #2, an L1-RSRP measurement of −94 dBm for CMR ID #2 and Rx beam ID #6, and an L1-RSRP measurement of −100 dBm for CMR #6 and Rx beam ID #7. A bit width associated with the Rx beam ID may be based at least in part on a quantity of Rx beams restricted by the current TD restriction window (e.g., the second TD restriction window).

As indicated above, FIG. 8 is provided as an example. Other examples may differ from what is described with regard to FIG. 8.

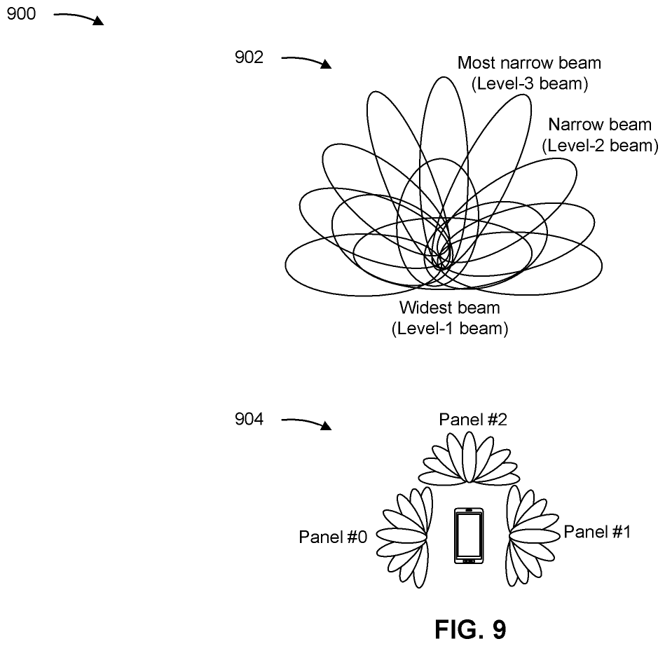

FIG. 9 is a diagram illustrating an example 900 associated with performing measurements associated with CMRs using restricted Rx beam subsets, in accordance with the present disclosure.

As shown by reference number 902, a UE may report total Rx beam number information. The total Rx beam number information may indicate level-1 beams, which may be associated with widest beams. The total Rx beam number information may indicate level-2 beams, which may be associated with narrow beams. The total Rx beam number information may indicate level-3 beams, which may be associated with most narrow beams.

As shown by reference number 904, a UE may report first order beam information regarding Rx beams. The first order beam information may indicate which Rx beams are widest in relation to other Rx beams, which Rx beams are narrow in relation to other Rx beams, and/or which Rx beams are most narrow in relation to other Rx beams. The first order beam information may indicate which Rx beams belong to which antenna panel. For example, each antenna panel may be associated with 8 Rx beams.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120) performs operations associated with performing measurements associated with CMRs using restricted Rx beam subsets.

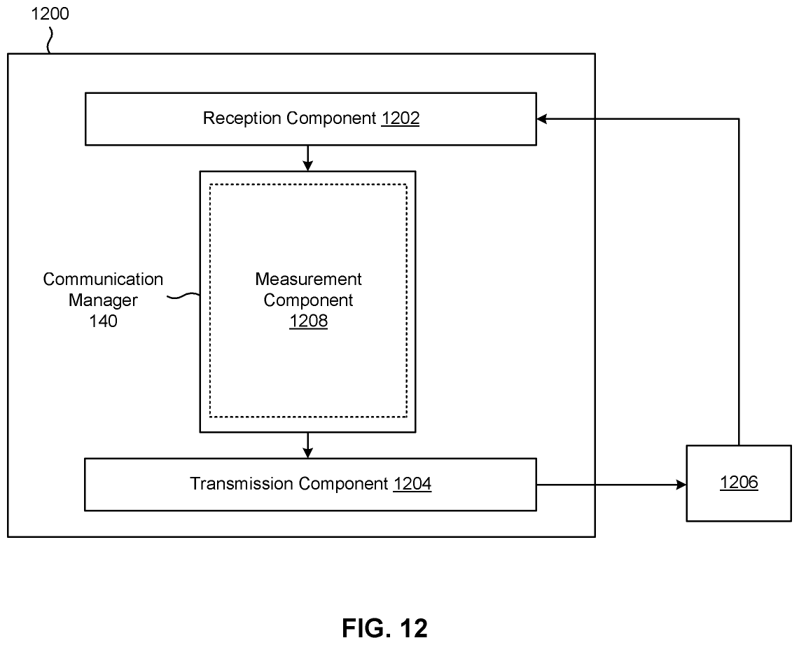

As shown in FIG. 10, in some aspects, process 1000 may include receiving, from a network node, a request to report measurements associated with CMRs (block 1010). For example, the UE (e.g., using communication manager 140 and/or reception component 1202, depicted in FIG. 12) may receive, from a network node, a request to report measurements associated with CMRs, as described above.

As further shown in FIG. 10, in some aspects, process 1000 may include performing, during a TD restriction window and based at least in part on the request, the measurements associated with the CMRs using Rx beams that are associated with a restricted Rx beam subset, wherein the restricted Rx beam subset is associated with the TD restriction window, and wherein the restricted Rx beam subset is a subset of a plurality of Rx beams associated with the UE (block 1020). For example, the UE (e.g., using communication manager 140 and/or measurement component 1208, depicted in FIG. 12) may perform, during a TD restriction window and based at least in part on the request, the measurements associated with the CMRs using Rx beams that are associated with a restricted Rx beam subset, wherein the restricted Rx beam subset is associated with the TD restriction window, and wherein the restricted Rx beam subset is a subset of a plurality of Rx beams associated with the UE, as described above.

As further shown in FIG. 10, in some aspects, process 1000 may include transmitting, to the network node, a CSI report that indicates the measurements associated with the CMRs (block 1030). For example, the UE (e.g., using communication manager 140 and/or transmission component 1204, depicted in FIG. 12) may transmit, to the network node, a CSI report that indicates the measurements associated with the CMRs, as described above.

Process 1000 may include additional aspects, such as any single aspect or any combination of aspects described below and/or in connection with one or more other processes described elsewhere herein.

In a first aspect, the CSI report indicates identifiers of the Rx beams associated with the restricted Rx beam subset that are used for performing the measurements associated with the CMRs.

In a second aspect, alone or in combination with the first aspect, different TD restriction windows are associated with different restricted Rx beam subsets.

In a third aspect, alone or in combination with one or more of the first and second aspects, process 1000 includes transmitting, to the network node and prior to the request, an indication of a quantity associated with the plurality of Rx beams associated with the UE.

In a fourth aspect, alone or in combination with one or more of the first through third aspects, process 1000 includes transmitting, to the network node and prior to the request, beam information that indicates one or more of a beam level associated with each of the plurality of Rx beams associated with the UE, or an antenna panel associated with each of the plurality of Rx beams associated with the UE.

In a fifth aspect, alone or in combination with one or more of the first through fourth aspects, process 1000 includes receiving, from the network node, an indication that a periodic CSI report or a semi-persistent CSI report is configured or activated, wherein N subsequent consecutive periodic or semi-persistent reports are based at least in part on the restricted Rx beam subset in accordance with the TD restriction window, or the Rx beams that are used for performing the measurements associated with the CMRs are based at least in part on the restricted Rx beam subset for N consecutive slots or subframes in accordance with the TD restriction window, and N is configured via a periodic CSI report setting or a semi-persistent CSI report setting, or N is indicated based at least in part on the semi-persistent CSI report being activated.

In a sixth aspect, alone or in combination with one or more of the first through fifth aspects, process 1000 includes receiving, from the network node, an indication of M restricted Rx beam subsets and corresponding Rx beam identifiers, wherein the restricted Rx beam subset is one of the M restricted Rx beam subsets, and the M restricted Rx beam subsets are used in a round-robin manner among different TD restriction windows.

In a seventh aspect, alone or in combination with one or more of the first through sixth aspects, process 1000 includes determining, from M restricted Rx beam subsets configured by the network node, the Rx beams to be used for performing the measurements associated with the CMRs.

In an eighth aspect, alone or in combination with one or more of the first through seventh aspects, process 1000 includes receiving, from the network node, an indication of the Rx beams to be used for performing the measurements associated with the CMRs during the TD restriction window.

In a ninth aspect, alone or in combination with one or more of the first through eighth aspects, process 1000 includes receiving, from the network node, an indication that dynamically changes the Rx beams to be used for performing the measurements associated with the CMRs or the restricted Rx beam subset associated with the TD restriction window.

In a tenth aspect, alone or in combination with one or more of the first through ninth aspects, process 1000 includes receiving, from the network node, an indication that dynamically changes the TD restriction window.

In an eleventh aspect, alone or in combination with one or more of the first through tenth aspects, process 1000 includes transmitting, to the network node, an indication of a recommendation for one or more of the Rx beams, the restricted Rx beam subset, or the TD restriction window, and receiving, from the network node, a configuration of one or more of the Rx beams, the restricted Rx beam subset, or the TD restriction window based at least in part on the indication of the recommendation.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with performing measurements associated with CMRs using restricted Rx beam subsets.

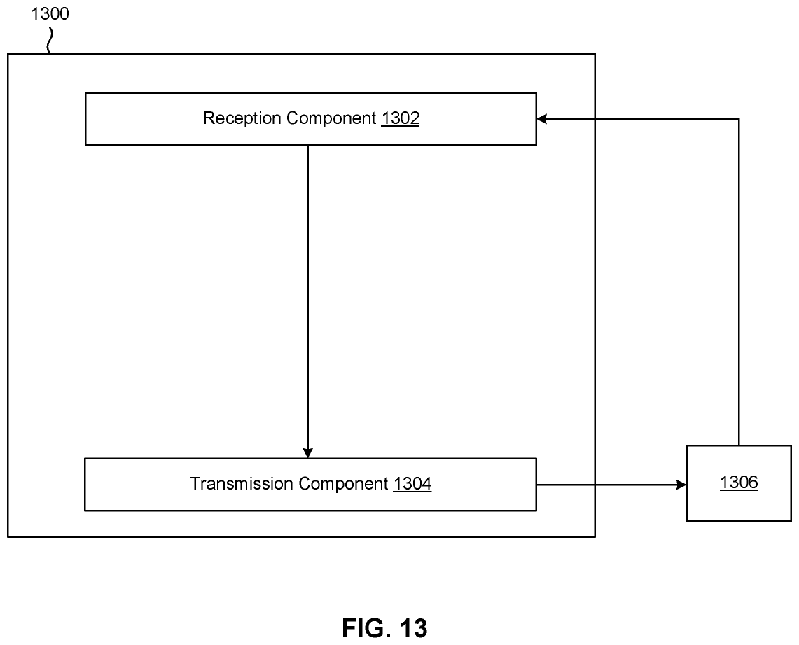

As shown in FIG. 11, in some aspects, process 1100 may include transmitting, to a UE, a request to report measurements associated with CMRs (block 1110). For example, the network node (e.g., using transmission component 1304, depicted in FIG. 13) may transmit, to a UE, a request to report measurements associated with CMRs, as described above.

As further shown in FIG. 11, in some aspects, process 1100 may include receiving, from the UE, a CSI report that indicates the measurements associated with the CMRs, wherein the measurements associated with the CMRs are associated with a TD restriction window and are performed based at least in part on Rx beams that are associated with a restricted Rx beam subset, and wherein the restricted Rx beam subset is associated with the TD restriction window (block 1120). For example, the network node (e.g., using reception component 1302, depicted in FIG. 13) may receive, from the UE, a CSI report that indicates the measurements associated with the CMRs, wherein the measurements associated with the CMRs are associated with a TD restriction window and are performed based at least in part on Rx beams that are associated with a restricted Rx beam subset, and wherein the restricted Rx beam subset is associated with the TD restriction window, as described above.

Process 1100 may include additional aspects, such as any single aspect or any combination of aspects described below and/or in connection with one or more other processes described elsewhere herein.

In a first aspect, process 1100 includes receiving, from the UE and prior to the request, an indication of a quantity associated with a plurality of Rx beams associated with the UE.

In a second aspect, alone or in combination with the first aspect, process 1100 includes receiving, from the UE and prior to the request, beam information that indicates one or more of a beam level associated with each of a plurality of Rx beams associated with the UE, or an antenna panel associated with each of the plurality of Rx beams associated with the UE.

In a third aspect, alone or in combination with one or more of the first and second aspects, process 1100 includes transmitting, to the UE, an indication of M restricted Rx beam subsets and corresponding Rx beam identifiers, wherein the restricted Rx beam subset is one of the M restricted Rx beam subsets, and wherein the M restricted Rx beam subsets are used in a round-robin manner among different TD restriction windows.

In a fourth aspect, alone or in combination with one or more of the first through third aspects, process 1100 includes transmitting, to the UE, an indication of the Rx beams to be used for performing the measurements associated with the CMRs during the TD restriction window.

In a fifth aspect, alone or in combination with one or more of the first through fourth aspects, process 1100 includes transmitting, to the UE, an indication that dynamically changes the Rx beams to be used for performing the measurements associated with the CMRs or the restricted Rx beam subset associated with the TD restriction window.

In a sixth aspect, alone or in combination with one or more of the first through fifth aspects, process 1100 includes transmitting, to the UE, an indication that dynamically changes the TD restriction window.

In a seventh aspect, alone or in combination with one or more of the first through sixth aspects, process 1100 includes receiving, from the UE, an indication of a recommendation for one or more of the Rx beams, the restricted Rx beam subset, or the TD restriction window, and transmitting, to the UE, a configuration of one or more of the Rx beams, the restricted Rx beam subset, or the TD restriction window based at least in part on the indication of the recommendation.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a measurement component 1208, among other examples.

In some aspects, the apparatus 1200 may be configured to perform one or more operations described herein in connection with FIGS. 7-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive, from a network node, a request to report measurements associated with CMRs. The measurement component 1208 may perform, during a TD restriction window and based at least in part on the request, the measurements associated with the CMRs using Rx beams that are associated with a restricted Rx beam subset, wherein the restricted Rx beam subset is associated with the TD restriction window, and wherein the restricted Rx beam subset is a subset of a plurality of Rx beams associated with the UE. The transmission component 1204 may transmit, to the network node, a CSI report that indicates the measurements associated with the CMRs.

The transmission component 1204 may transmit, to the network node and prior to the request, an indication of a quantity associated with the plurality of Rx beams associated with the UE. The transmission component 1204 may transmit, to the network node and prior to the request, beam information that indicates one or more of: a beam level associated with each of the plurality of Rx beams associated with the UE, or an antenna panel associated with each of the plurality of Rx beams associated with the UE.

The reception component 1202 may receive, from the network node, an indication that a periodic CSI report or a semi-persistent CSI report is configured or activated, wherein N subsequent consecutive periodic or semi-persistent reports are based at least in part on the restricted Rx beam subset in accordance with the TD restriction window, or the Rx beams that are used for performing the measurements associated with the CMRs are based at least in part on the restricted Rx beam subset for N consecutive slots or subframes in accordance with the TD restriction window, and wherein N is configured via a periodic CSI report setting or a semi-persistent CSI report setting, or N is indicated based at least in part on the semi-persistent CSI report being activated.

The reception component 1202 may receive, from the network node, an indication of M restricted Rx beam subsets and corresponding Rx beam identifiers, wherein the restricted Rx beam subset is one of the M restricted Rx beam subsets, and wherein the M restricted Rx beam subsets are used in a round-robin manner among different TD restriction windows. The reception component 1202 may receive, from the network node, an indication of the Rx beams to be used for performing the measurements associated with the CMRs during the TD restriction window.

The reception component 1202 may receive, from the network node, an indication that dynamically changes the Rx beams to be used for performing the measurements associated with the CMRs or the restricted Rx beam subset associated with the TD restriction window. The reception component 1202 may receive, from the network node, an indication that dynamically changes the TD restriction window. The transmission component 1204 may transmit, to the network node, an indication of a recommendation for one or more of the Rx beams, the restricted Rx beam subset, or the TD restriction window. The reception component 1202 may receive, from the network node, a configuration of one or more of the Rx beams, the restricted Rx beam subset, or the TD restriction window based at least in part on the indication of the recommendation.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIGS. 7-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The transmission component 1304 may transmit, to a UE, a request to report measurements associated with CMRs. The reception component 1302 may receive, from the UE, a CSI report that indicates the measurements associated with the CMRs, wherein the measurements associated with the CMRs are associated with a TD restriction window and are performed based at least in part on Rx beams that are associated with a restricted Rx beam subset, and wherein the restricted Rx beam subset is associated with the TD restriction window.

The reception component 1302 may receive, from the UE and prior to the request, an indication of a quantity associated with a plurality of Rx beams associated with the UE. The reception component 1302 may receive, from the UE and prior to the request, beam information that indicates one or more of: a beam level associated with each of a plurality of Rx beams associated with the UE, or an antenna panel associated with each of the plurality of Rx beams associated with the UE. The transmission component 1304 may transmit, to the UE, an indication of M restricted Rx beam subsets and corresponding Rx beam identifiers, wherein the restricted Rx beam subset is one of the M restricted Rx beam subsets, and wherein the M restricted Rx beam subsets are used in a round-robin manner among different TD restriction windows.

The transmission component 1304 may transmit, to the UE, an indication of the Rx beams to be used for performing the measurements associated with the CMRs during the TD restriction window. The transmission component 1304 may transmit, to the UE, an indication that dynamically changes the Rx beams to be used for performing the measurements associated with the CMRs or the restricted Rx beam subset associated with the TD restriction window. The transmission component 1304 may transmit, to the UE, an indication that dynamically changes the TD restriction window. The reception component 1302 may receive, from the UE, an indication of a recommendation for one or more of the Rx beams, the restricted Rx beam subset, or the TD restriction window. The transmission component 1304 may transmit, to the UE, a configuration of one or more of the Rx beams, the restricted Rx beam subset, or the TD restriction window based at least in part on the indication of the recommendation.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by an apparatus of a user equipment (UE), comprising: receiving, from a network node, a request to report measurements associated with channel measurement resources (CMRs); performing, during a time domain (TD) restriction window and based at least in part on the request, the measurements associated with the CMRs using receive (Rx) beams that are associated with a restricted Rx beam subset, wherein the restricted Rx beam subset is associated with the TD restriction window, and wherein the restricted Rx beam subset is a subset of a plurality of Rx beams associated with the UE; and transmitting, to the network node, a channel state information (CSI) report that indicates the measurements associated with the CMRs.

Aspect 2: The method of Aspect 1, wherein the CSI report indicates identifiers of the Rx beams associated with the restricted Rx beam subset that are used for performing the measurements associated with the CMRs.

Aspect 3: The method of any of Aspects 1 through 2, wherein different TD restriction windows are associated with different restricted Rx beam subsets.

Aspect 4: The method of any of Aspects 1 through 3, further comprising: transmitting, to the network node and prior to the request, an indication of a quantity associated with the plurality of Rx beams associated with the UE.

Aspect 5: The method of any of Aspects 1 through 4, further comprising: transmitting, to the network node and prior to the request, beam information that indicates one or more of: a beam level associated with each of the plurality of Rx beams associated with the UE, or an antenna panel associated with each of the plurality of Rx beams associated with the UE.

Aspect 6: The method of any of Aspects 1 through 5, further comprising: receiving, from the network node, an indication that a periodic CSI report or a semi-persistent CSI report is configured or activated, wherein N subsequent consecutive periodic or semi-persistent reports are based at least in part on the restricted Rx beam subset in accordance with the TD restriction window, or the Rx beams that are used for performing the measurements associated with the CMRs are based at least in part on the restricted Rx beam subset for N consecutive slots or subframes in accordance with the TD restriction window, and wherein N is configured via a periodic CSI report setting or a semi-persistent CSI report setting, or N is indicated based at least in part on the semi-persistent CSI report being activated.

Aspect 7: The method of any of Aspects 1 through 6, further comprising: receiving, from the network node, an indication of M restricted Rx beam subsets and corresponding Rx beam identifiers, wherein the restricted Rx beam subset is one of the M restricted Rx beam subsets, and wherein the M restricted Rx beam subsets are used in a round-robin manner among different TD restriction windows.

Aspect 8: The method of any of Aspects 1 through 7, wherein the Rx beams to be used for performing the measurements associated with the CMRs are determined from M restricted Rx beam subsets configured by the network node.

Aspect 9: The method of any of Aspects 1 through 8, further comprising: receiving, from the network node, an indication of the Rx beams to be used for performing the measurements associated with the CMRs during the TD restriction window.

Aspect 10: The method of any of Aspects 1 through 9, further comprising: receiving, from the network node, an indication that dynamically changes the Rx beams to be used for performing the measurements associated with the CMRs or the restricted Rx beam subset associated with the TD restriction window.

Aspect 11: The method of any of Aspects 1 through 10, further comprising: receiving, from the network node, an indication that dynamically changes the TD restriction window.

Aspect 12: The method of any of Aspects 1 through 11, further comprising: transmitting, to the network node, an indication of a recommendation for one or more of the Rx beams, the restricted Rx beam subset, or the TD restriction window; and receiving, from the network node, a configuration of one or more of the Rx beams, the restricted Rx beam subset, or the TD restriction window based at least in part on the indication of the recommendation.

Aspect 13: A method of wireless communication performed by an apparatus of a network node, comprising: transmitting, to a user equipment (UE), a request to report measurements associated with channel measurement resources (CMRs); and receiving, from the UE, a channel state information (CSI) report that indicates the measurements associated with the CMRs, wherein the measurements associated with the CMRs are associated with a time domain (TD) restriction window and are performed based at least in part on receive (Rx) beams that are associated with a restricted Rx beam subset, and wherein the restricted Rx beam subset is associated with the TD restriction window.

Aspect 14: The method of Aspect 13, further comprising: receiving, from the UE and prior to the request, an indication of a quantity associated with a plurality of Rx beams associated with the UE.

Aspect 15: The method of any of Aspects 13 through 14, further comprising: receiving, from the UE and prior to the request, beam information that indicates one or more of: a beam level associated with each of a plurality of Rx beams associated with the UE, or an antenna panel associated with each of the plurality of Rx beams associated with the UE.

Aspect 16: The method of any of Aspects 13 through 15, further comprising: transmitting, to the UE, an indication of M restricted Rx beam subsets and corresponding Rx beam identifiers, wherein the restricted Rx beam subset is one of the M restricted Rx beam subsets, and wherein the M restricted Rx beam subsets are used in a round-robin manner among different TD restriction windows.

Aspect 17: The method of any of Aspects 13 through 16, further comprising: transmitting, to the UE, an indication of the Rx beams to be used for performing the measurements associated with the CMRs during the TD restriction window.

Aspect 18: The method of any of Aspects 13 through 17, further comprising: transmitting, to the UE, an indication that dynamically changes the Rx beams to be used for performing the measurements associated with the CMRs or the restricted Rx beam subset associated with the TD restriction window.

Aspect 19: The method of any of Aspects 13 through 18, further comprising: transmitting, to the UE, an indication that dynamically changes the TD restriction window.

Aspect 20: The method of any of Aspects 13 through 19, further comprising: receiving, from the UE, an indication of a recommendation for one or more of the Rx beams, the restricted Rx beam subset, or the TD restriction window; and transmitting, to the UE, a configuration of one or more of the Rx beams, the restricted Rx beam subset, or the TD restriction window based at least in part on the indication of the recommendation.

Aspect 21: An apparatus for wireless communication at a device, comprising a processor; memory coupled with the processor; and instructions stored in the memory and executable by the processor to cause the apparatus to perform the method of one or more of Aspects 1-12.

Aspect 22: A device for wireless communication, comprising a memory and one or more processors coupled to the memory, the one or more processors configured to perform the method of one or more of Aspects 1-12.

Aspect 23: An apparatus for wireless communication, comprising at least one means for performing the method of one or more of Aspects 1-12.

Aspect 24: A non-transitory computer-readable medium storing code for wireless communication, the code comprising instructions executable by a processor to perform the method of one or more of Aspects 1-12.

Aspect 25: A non-transitory computer-readable medium storing a set of instructions for wireless communication, the set of instructions comprising one or more instructions that, when executed by one or more processors of a device, cause the device to perform the method of one or more of Aspects 1-12.

Aspect 26: An apparatus for wireless communication at a device, comprising a processor; memory coupled with the processor; and instructions stored in the memory and executable by the processor to cause the apparatus to perform the method of one or more of Aspects 13-20.

Aspect 27: A device for wireless communication, comprising a memory and one or more processors coupled to the memory, the one or more processors configured to perform the method of one or more of Aspects 13-20.

Aspect 28: An apparatus for wireless communication, comprising at least one means for performing the method of one or more of Aspects 13-20.

Aspect 29: A non-transitory computer-readable medium storing code for wireless communication, the code comprising instructions executable by a processor to perform the method of one or more of Aspects 13-20.

Aspect 30: A non-transitory computer-readable medium storing a set of instructions for wireless communication, the set of instructions comprising one or more instructions that, when executed by one or more processors of a device, cause the device to perform the method of one or more of Aspects 13-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
receive, from a network node, a request to report measurements associated with channel measurement resources (CMRs);
perform, during a time domain (TD) restriction window and based at least in part on the request, the measurements associated with the CMRs using receive (Rx) beams that are associated with a restricted Rx beam subset, wherein the restricted Rx beam subset is associated with the TD restriction window, and wherein the restricted Rx beam subset is a subset of a plurality of Rx beams associated with the UE; and
transmit, to the network node, a channel state information (CSI) report that indicates the measurements associated with the CMRs.

2. The apparatus of claim 1, wherein the CSI report indicates identifiers of the Rx beams associated with the restricted Rx beam subset that are used for performing the measurements associated with the CMRs.

3. The apparatus of claim 1, wherein different TD restriction windows are associated with different restricted Rx beam subsets.

4. The apparatus of claim 1, wherein the one or more processors are further configured to:
transmit, to the network node and prior to the request, an indication of a quantity associated with the plurality of Rx beams associated with the UE.

5. The apparatus of claim 1, wherein the one or more processors are further configured to:
transmit, to the network node and prior to the request, beam information that indicates one or more of: a beam level associated with each of the plurality of Rx beams associated with the UE, or an antenna panel associated with each of the plurality of Rx beams associated with the UE.

6. The apparatus of claim 1, wherein the one or more processors are further configured to:
receive, from the network node, an indication that a periodic CSI report or a semi-persistent CSI report is configured or activated, wherein N subsequent consecutive periodic or semi-persistent reports are based at least in part on the restricted Rx beam subset in accordance with the TD restriction window, or the Rx beams that are used for performing the measurements associated with the CMRs are based at least in part on the restricted Rx beam subset for N consecutive slots or subframes in accordance with the TD restriction window, and wherein N is configured via a periodic CSI report setting or a semi-persistent CSI report setting, or N is indicated based at least in part on the semi-persistent CSI report being activated.

7. The apparatus of claim 1, wherein the one or more processors are further configured to:
receive, from the network node, an indication of M restricted Rx beam subsets and corresponding Rx beam identifiers, wherein the restricted Rx beam subset is one of the M restricted Rx beam subsets, and wherein the M restricted Rx beam subsets are used in a round-robin manner among different TD restriction windows.

8. The apparatus of claim 1, wherein the Rx beams to be used for performing the measurements associated with the CMRs are determined from M restricted Rx beam subsets configured by the network node.

9. The apparatus of claim 1, wherein the one or more processors are further configured to:
receive, from the network node, an indication of the Rx beams to be used for performing the measurements associated with the CMRs during the TD restriction window.

10. The apparatus of claim 1, wherein the one or more processors are further configured to:
receive, from the network node, an indication that dynamically changes the Rx beams to be used for performing the measurements associated with the CMRs or the restricted Rx beam subset associated with the TD restriction window.

11. The apparatus of claim 1, wherein the one or more processors are further configured to:
receive, from the network node, an indication that dynamically changes the TD restriction window.

12. The apparatus of claim 1, wherein the one or more processors are further configured to:
transmit, to the network node, an indication of a recommendation for one or more of the Rx beams, the restricted Rx beam subset, or the TD restriction window; and
receive, from the network node, a configuration of one or more of the Rx beams, the restricted Rx beam subset, or the TD restriction window based at least in part on the indication of the recommendation.

13. An apparatus for wireless communication at a network node, comprising:
a memory; and
one or more processors, coupled to the memory, configured to:
transmit, to a user equipment (UE), a request to report measurements associated with channel measurement resources (CMRs); and
receive, from the UE, a channel state information (CSI) report that indicates the measurements associated with the CMRs, wherein the measurements associated with the CMRs are associated with a time domain (TD) restriction window and are performed based at least in part on receive (Rx) beams that are associated with a restricted Rx beam subset, and wherein the restricted Rx beam subset is associated with the TD restriction window.

14. The apparatus of claim 13, wherein the one or more processors are further configured to:
receive, from the UE and prior to the request, an indication of a quantity associated with a plurality of Rx beams associated with the UE.

15. The apparatus of claim 13, wherein the one or more processors are further configured to:
receive, from the UE and prior to the request, beam information that indicates one or more of: a beam level associated with each of a plurality of Rx beams associated with the UE, or an antenna panel associated with each of the plurality of Rx beams associated with the UE.

16. The apparatus of claim 13, wherein the one or more processors are further configured to:
transmit, to the UE, an indication of M restricted Rx beam subsets and corresponding Rx beam identifiers, wherein the restricted Rx beam subset is one of the M restricted Rx beam subsets, and wherein the M restricted Rx beam subsets are used in a round-robin manner among different TD restriction windows.

17. The apparatus of claim 13, wherein the one or more processors are further configured to:
transmit, to the UE, an indication of the Rx beams to be used for performing the measurements associated with the CMRs during the TD restriction window.

18. The apparatus of claim 13, wherein the one or more processors are further configured to:
transmit, to the UE, an indication that dynamically changes the Rx beams to be used for performing the measurements associated with the CMRs or the restricted Rx beam subset associated with the TD restriction window.

19. The apparatus of claim 13, wherein the one or more processors are further configured to:
transmit, to the UE, an indication that dynamically changes the TD restriction window.

20. The apparatus of claim 13, wherein the one or more processors are further configured to:
receive, from the UE, an indication of a recommendation for one or more of the Rx beams, the restricted Rx beam subset, or the TD restriction window; and
transmit, to the UE, a configuration of one or more of the Rx beams, the restricted Rx beam subset, or the TD restriction window based at least in part on the indication of the recommendation.

21-30. (canceled)
